(19) United States
(12) Patent Application Publication
(10) Pub. No.: US 2010/0306077 A1
(43) Pub. Date: Dec. 2, 2010

(54) System and method of facilitating transactions

(76) Inventor: Lisa Lloyd, Tucson, AZ (US)

Correspondence Address: Steven Thrasher, 391 Sandhill Dr., Richardson, TX, 75080, US

(21) Appl. No.: 12/658,435

(22) Filed: Feb. 10, 2010

Related U.S. Application Data
(60) Provisional application No. 61/183,448, filed on Jun. 2, 2009.

(51) Int. Cl. G06Q 30/00; G06Q 40/00

(52) U.S. Cl. 705/26; 705/39

(57) ABSTRACT

The invention teaches methods for facilitating financial transactions for online retailers/wholesalers/merchants by pre-associating a good offered for sale with one or more available vendors for that item, and by automatically notifying the vendor of the sale and automatically sending the vendor its cut of the sales price. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CROSS-REFERENCE TO RELATED APPLICATIONS

This application is related to, and claims priority from U.S. Provisional Patent Application 61/183,448 entitled Computer Readable Medium for E-Banking, to Lloyd, filed Jun. 2, 2009.

### TECHNICAL FIELD OF THE INVENTION

The invention relates to increasing the adoption and use of internet transaction solutions.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

The advent of internet merchant services and payment systems have proliferated the number of persons and businesses (“merchants”) that conduct commerce online, and are generally referred to as “e-tailers.” E-tailers use an internet web page to create an online store presence. Well known e-tailers include Amazon.com, bestbuy.com, and the like. Further, it is increasingly common for relatively small suppliers of product to have an e-tailer presence while using merchant processors to pay for “drop-shipments” of the product(s) the consumer wants, directly from manufacturers, distributors, or vendors (collectively, “suppliers”) to deliver the product. This effectively gives a merchant the ability to sell product (including services) without ever physically taking possession of the product.

However, when a customer of the merchant purchases multiple items from multiple disparate suppliers, there is considerable time required to manually generate a payment and order for each supplier. The present invention provides an elegant solution to this time consuming process.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 is a flow diagram of an online purchasing transaction.

FIG. 2 illustrates an enhanced purchasing transaction algorithm.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for-functioning-” or “step for-functioning-” in the Claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine. Furthermore, acts and steps and methods may be implemented as software modules, scripts, applets, and the like, or straight-coded, and may be directed by a users via icon and graphics which do not require programming at all.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Unless otherwise indicated, acronyms used have the ordinary meaning of those acronyms in the context presented, and are readily understood by those of ordinary skill in the art. Words and phrases are to be given their ordinary plain meaning unless indicated otherwise.

### DESCRIPTION OF THE DRAWINGS

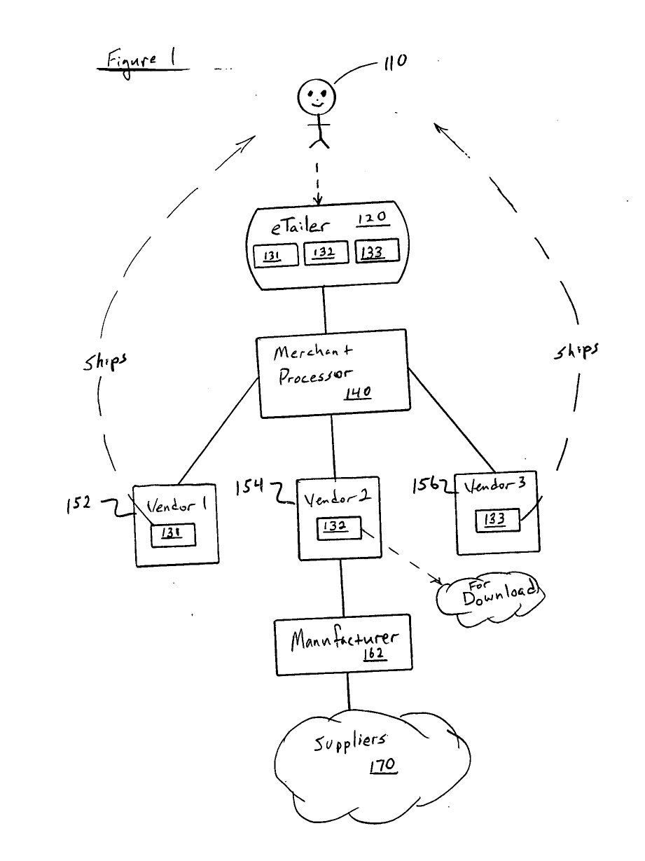

FIG. 1 is a flow diagram of an online purchasing transaction.

### Standard Flow

When a customer 110 goes to an e-tailer 120 to make a purchase, they select items for purchase by placing them into a virtual shopping cart—say for three items: item one 131, item two 132, and item three 133. The e-tailer 120 then has a merchant processor 140, such as PayPal, collect the proceeds for the customer 110, and then the merchant processor 140 deposits funds into that e-tailer's merchant account. Next, the e-tailer 120 sends an email, phone call, fax, or otherwise contacts the vendors 152, 154, 156 of each of the items purchased (in this example let us designate three vendors, each responsible and named for the item number they are to ship), as illustrated by the dashed lines. The vendors ship the items one through three to the customer, and charge the e-tailer for the items they ship to the customer. This is commonly called “drop-shipping.”

Although it is uncommon today for vendors to be manufacturers, vendors may be manufacturers, and it is foreseeable that manufacturers can perform the vendor function. In those situations in which the vendor is not a merchant, yet a third layer of transactions occur as illustrated in FIG. 1, between the vendor 154 and manufacturer 162 in a similar manner, and so forth all the way through to the raw materials suppliers 170. Each transaction involving materials is discrete in that it requires a separate, inefficient financial transaction.

As previously pointed out, to communicate with each vendor 152-156 so that the vendor 152-156 can make a shipment to the customer 110 is a physically time consuming step for the e-tailer 120. So, the e-tailer 110 has to contact the vendors 152-156 and tell them to whom to ship, and the vendor 152-156 has to take time to charge the e-tailer 120, and mail the order. Often, the vendor gives the e-tailer 120 terms and forces the e-tailer 120 to wait to get paid “net 30” or the like, at which point they invoice the e-tailer 120 and go through standard accounting practice—again, this requires a second merchant processing event which may involve additional merchant processors. Accordingly, there are typically two or more merchant transactions occurring for every e-tailer shopping cart transaction that gets processed, multiple vendor-manufacturer transactions, and multiple manufacturer-supplier transactions for every consumer purchase. Of course, in practice, a customer may purchase any number of items, and the complexity and waste increases as the number of items purchased from disparate vendors increases.

The present invention solves this repetitive transaction overlap and the requirement for separate merchant processor data entry by having e-tailors pre-designate supplier/vendors for supplying a particular item at a particular price (or a lower-bid price among competing suppliers) through a centralized single merchant processor. In one embodiment, utilizing the system herein described can give tremendous leverage over the time-value of money in that it can be used to “collapse” the time-delays in the payment processes (particularly for trusted sources), and/or allows the vendor to control when the payments are actually occurring to its benefit.

### EXEMPLARY PREFERRED METHODOLOGY

The invention contemplates that a retailer or e-tailer (collectively, “e-tailer”) will spend a few moments while setting up their product or service offerings online, in order to save a lot of time later. Specifically, when the e-tailer sets up its account to accept money for payment of an item, the e-tailer:

(A) either 1) identifies the vendor who is to be paid for the item or 2) identifies a number of vendors that may supply an item based on selected criteria, described in more detail below; and

(B) for each item-vendor combination, the e-tailer identifies the amount of money that the vendor is to receive for the item, expressed as a percentage or a fixed amount.

Other transaction criteria may supplement these acts, such as designating a day on which the vendor is to be paid, typically expressed as a number of days to pass following a transaction. Other supplemental acts are discussed below.

Thereafter, when an item is purchased, the acts of communicating with the vendor to pay the vendor for the item, and of providing the shipping information are automated, saving the vendor substantial time. An exemplary process of a purchase being made is discussed below to help clarify this methodology.

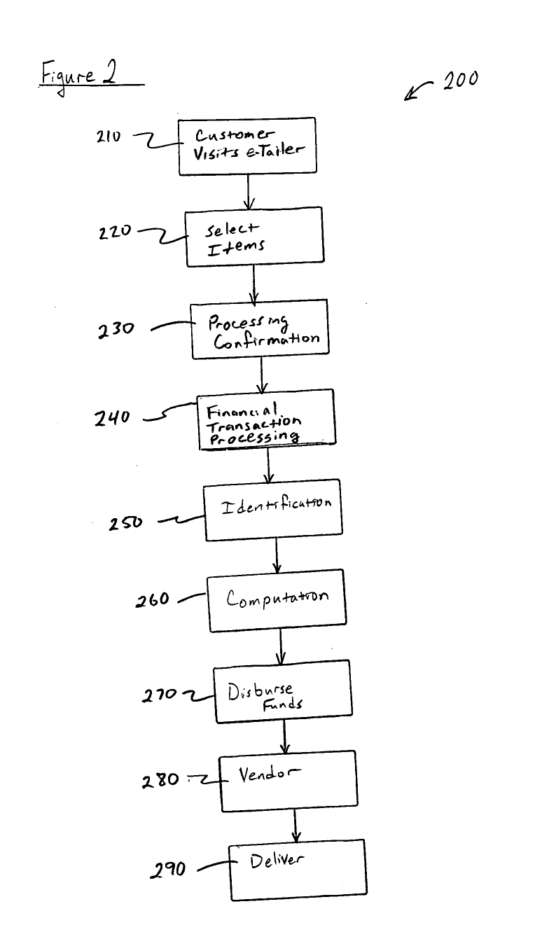

FIG. 2 illustrates an enhanced purchasing transaction algorithm 200 (the algorithm 200) described in conjunction and reference to FIG. 1. The algorithm 200 initiates when a customer 110 “visits” an e-tailer website (including mobile sites) 210. Typically, the customer 110 does this by logging onto an e-tailer website with a user name and password or in other manners known in the arts, such as click IDs offered by BioSig-ID (R) of Denton, Tex. Then, the method proceeds to a customer selects items 220 act. As is known in the arts, the customer 110 typically selects one or more items by clicking on it, typing the item name in, uploading a list from a cell phone or a computer or some other storage means they have, or the like.

Next, the algorithm 200 proceeds to a check-out processing confirmation act 230 in which the consumer 110 checks out. Here, the customer 110 enters their personal information, and at this point if they haven't already logged in to create a retailer/e-tailer proprietary consumer account for return purposes, they are typically prompted to enter this information for verification and/or future purchase purposes (there are a few e-tailers that allow for check-out without signing up for an account, and the invention encompasses both cases). Next, a financial transaction processing act 240 occurs in which the money is moved from the customer's account to the account of the e-tailer 120.

The algorithm 200 continues to an identification (ID) act 250, in which the algorithm 200 matches each of the purchased items 250 to the vendor (or other up-supply chain source) of that item, and the amount that vendor should be credited. At this stage, it should be noted that the vendor may be selected, rather than merely linearly associated with a respective item or items. Accordingly, the vendor may be selected based on the best price available, delivery method (in person, versus via mail, etc.), available terms of purchase such as real-time payment to the vendor, a quality/reliability score, or proximity to consumer, for example.

In describing the next act, a computation act 260, it is important to remember the association acts mentioned above, and it is helpful to explore these associations via an example. Consider that PayPal (R) could be the merchant services provider for the e-tailer and vendor (the invention is more efficient when the vendor and the e-tailer are both members of that particular merchant service provider). In this example PayPal as the merchant service provider/processor asks the e-tailer two more questions: 1) who the vendor is for that item—to associate the vendor with the item purchased by the consumer, and 2) the percentage amount or the dollar amount to be allocated to that vendor whenever that item is purchased. To make the association and/or purchase price allocation, the e-tailer preferably enters the vendor's email address into a text box, but could also accomplish the task via drop-down menus, data entry boxes, or other means. Continuing with this example, assume the e-tailer had indicated on that form that the vendor is to receive 50% of that item's price in the transaction. Accordingly, if an item is purchased for $10, the merchant processor (here, PayPal) would process $10 from the consumer, then Pay Pal would know that each the vendor and merchant are to receive $5 of the customer's payment, and would accordingly deliver $5 to each. For accounting purposes, however, it may be required to first process $10 to the e-tailer, and then $5 from the e-tailer to the vendor. The merchant processor 140 could elect to charge a fee for the transaction, or could provide the service as an added value program, and these program fees can be generated via software as part of the algorithm 200.

The algorithm 200 then sends the funds and order information to each appropriate vendor in a disburse funds act 270. Next in a vendor act 280, the vendor is notified via any available means that the item is ordered, and preferably that the funds for that transaction have been received. Although it is preferred that these notices are completed simultaneously, it is understood that they may comprise their own discrete steps without departing from the scope and teachings of the invention. Further, here it is the merchant services provider/merchant processor 140 that notifies the vendor(s) (of course the e-tailer could notify or otherwise communicate with the vendor(s)). Next, in a delivery act 290, an item or service is delivered to the customer by the vendor or other service, such as a fulfillment center.

It is appreciated that internet transactions are not taxed today. However, if they were, taxes could be allocated per whatever laws are passed. Herein lies another advantage in the invention: the pre-directing of funds could generate transactions that lawfully minimize tax consequences and accounting.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. It is therefore the intention that the appended claims and their equivalents be interpreted as broadly as possible in view of the prior art to include all such variations and modifications.

I claim:

1. A method implemented as software modules, comprising:
associating a first item to be offered for sale with a source for the first item, the first item having a sale price;
further associating the first item to be offered for sale with a source price;
receiving an indication of a purchase of the first item; and
receiving a payment for the first item, the payment having deducted therefrom the source price.

2. The method of claim 1 wherein the source price is expressed as a value.

3. The method of claim 1 wherein the source price is expressed as a percentage of the sale price.

4. The method of claim 1 further comprising automatically generating an order to ship the first item to a customer.

5. The method of claim 1 wherein the source price is excluded from the payment for the first item.

6. A method implemented as software modules, comprising:
receiving an association of a first item to be offered for sale with a source for the first item, the first item having a first sale price;
receiving an association a second item to be offered for sale with a source for the second item, the second item having a second sale price;
receiving an association of the first item to be offered for sale with a first source price;
receiving an association of the second item to be offered for sale with a second source price;
receiving an indication of a purchase of the first item at a first purchase price, and receiving an indication of a purchase of the second item at a second purchase price;
receiving an indication of a payment for the first item and the second item;
automatically generating a notice of purchase to a supplier of the first item, and automatically generating a notice of purchase to a supplier of the second item;
directing a payment to an etailer, the payment having deducted therefrom the first source price and the second source price;
directing a payment to the supplier of the first item; and
directing a payment to the supplier of the second item.

7. The method of claim 6 wherein the notice of purchase includes an address to which either the first item or the second item is to be shipped.

8. The method of claim 6 wherein the source price is expressed as a percentage of the sale price.

9. The method of claim 6 wherein the first item is software for download.

10. The method of claim 6 further comprising the association, indication, generation, and directing of a plurality of items.

11. The method of claim 6 wherein the entire purchase price is credited to the etailer prior to deducting payments for the first item and the second item.

12. The method of claim 6 wherein the act of association associates the first item with a plurality of suppliers.

13. The method of claim 12 wherein the plurality of suppliers are sorted by geographic location.

14. The method of claim 12 wherein the plurality of suppliers are sorted by item price.

15. A memory for storing data for access by an application program being executed on a data processing system, comprising:
associating a first item to be offered for sale with a source for the first item, the first item having a sale price;
further associating the first item to be offered for sale with a source price;
receiving an indication of a purchase of the first item; and
receiving a payment for the first item, the payment having deducted therefrom the source price.

16. The method of claim 15 wherein the source price is expressed as a value.

17. The method of claim 15 wherein the source price is expressed as a percentage of the sale price.

18. The method of claim 15 further comprising automatically generating an order to ship the first item to a customer.

19. The method of claim 15 wherein the source price is excluded from the payment for the first item.
